(19) United States
(12) Patent Application Publication
(10) Pub. No.: US 2003/0196108 A1
(43) Pub. Date: Oct. 16, 2003

(54) System and techniques to bind information objects to security labels

(76) Inventor: Kenneth C. Kung, Cerritos, CA (US)

Correspondence Address: Paul D. Durkee, Daly, Crowley & Mofford, LLP, Suite 101, 275 Turnpike Street, Canton, MA, 02021-2310, US

(21) Appl. No.: 10/404,703

(22) Filed: Apr. 1, 2003

Related U.S. Application Data
(60) Provisional application No. 60/372,489, filed on Apr. 12, 2002.

(51) Int. Cl. H04L 9/32

(52) U.S. Cl. 713/200; 713/175

(57) ABSTRACT

A method to providing multilevel security for a data object requested by a workstation user includes providing a security label for the data object, associating security rules including a security clearance level for the data object with the security label, binding the security label to the data object, validating the correctness of the security label, associating the user's security clearance level with at least one user certificate, verifying the at least one user certificate, and determining whether the user has clearance to receive the requested data.

### CROSS REFERENCE TO RELATED APPLICATION

This application claims the benefit of U.S. Provisional Patent Application No. 50/372,489, filed on Apr. 12, 2002, which is incorporated herein by reference.

### STATEMENT REGARDING FEDERALLY SPONSORED RESEARCH

Not Applicable.

### FIELD OF THE INVENTION

This invention relates generally to multilevel security systems and more particularly to systems and techniques to to bind data objects to security labels.

### BACKGROUND OF THE INVENTION

In commercial and military information technology applications, it is often desirable to control access to information having different levels of security. In a multilevel secure computer system, where not all users are trusted to handle all data objects, mandatory access control mechanisms are oftened used to enforce a multilevel security policy. The mandatory access control mechanisms determine whether a particular user has the proper privilege (via his or her security clearance level or other privilege indicator) to access a data object.

In conventional secure operating systems, a security label is often associated with specific data files. These files are protected by the secure operating system. However, when these files are exported from the operating system, the receiving system cannot always ascertain the trustworthiness of the security label and the file. Without this trust, all users must be trusted at a level equal to the highest clearance levelr in order to see to see all information within the system. This is an expensive solution and unworkable when operating in joint or coalition military environments. Conventional methods to protect information in transit include encrypting the data with a different key for each security level. This protection stops as soon as the information is decrypted at an information receiving system.

It would, therefore, be desirable to control the distribution of data objects within a multilevel security system. It would be further desirable to securely bind a security label to an object and enforce a multilevel security policy in a distributed environment.

### SUMMARY OF THE INVENTION

In accordance with the present invention, a method to providing multilevel security for a data object requested by a workstation user includes providing a security label for the data object, associating security rules including a security clearance level for the data object with the security label, binding the security label to the data object, validating the correctness of the security label, associating the user's security clearance level with at least one user certificate, verifying at least one user certificate, and determining whether the user has clearance to receive the requested data.

With such an arrangement, a low cost multilevel security system is provided which controls the distribution of data objects within a multilevel security system by securely binding a security label to a data object and enforcing the associated security rules in a distributed environment. In addition, the multilevel security protection is extended into the respective operating systems and provides finer access control for granting the user access privilege based on both security levels and the handling instructions (e.g., no foreign access, but releasable to UK, Canada and Australia). The multilevel security protection can be applied to individual files, paragraphs, sentences, words, and the data bit level.

### BRIEF DESCRIPTION OF THE DRAWINGS

The foregoing features of this invention, as well as the invention itself, may be more fully understood from the following description of the drawings in which:

FIG. 1 is a block diagram of a multilevel security, multilevel protection (MLS/MLP) system including security integration code and information network according to the invention;

FIG. 2 is a flow diagram illustrating the steps to login to the MLS/MLP system of FIG. 1, and to request and receive data objects;

FIG. 3 is a flow diagram illustrating the steps to launch an application and receive a remote data object from the MLS/MLP system of FIG. 1;

FIG. 4 is a flow diagram illustrating the steps to enforce the security rules included in a security label provided by the MLS/MLP system of FIG. 1;

FIG. 5 is a flow diagram illustrating the steps to issue a mission execution order using the MLS/MLP system of FIG. 1.

FIG. 6 is a schematic diagram of a multilevel secured data object includes a security label, data object, and digital signature according to the invention;

FIG. 7 is an exemplary representation of multiple levels of security in an electronic document modeled as a collection of eXtensible Markup Language (XML) tags according to the invention;

FIG. 7A is an exemplary XML Security Label data type definition for the Security Label of FIG. 7;

FIGS. 8 and 8A illustrate a set of security levels and a set of categories combined to form a partial ordering; and

FIG. 9 illustrates authorized and unauthorized transactions accessing secure data objects

### DETAILED DESCRIPTION OF THE INVENTION

Before providing a detailed description of the invention, it may be helpful to define some of the terms used in the description. As used herein, “security integration code” refers to a distributed application, which provides some of the multilevel security, multilevel protection functions described below. The functions of the security integration code can be distributed over the various workstations, platforms, database engines, and network components. A multilevel security, multilevel protection system is also referred to as a MLS/MLP system.

As used herein, the term “data object” includes a file, part of a file, a paragraph, a sentence, a word, a database field, or a column or a row in a relational database table. The data object (also referred to as an information object) can also include an image and, if distinguishable, a portion of an image.

The term “security label,” as used herein, refers to data associated with a particular data object which includes one or more security rules, for example a security level classification, and can optionally include restrictions, caveats, handling instructions and other security related data for controling access to the data object. A data object having a associated security label is referred to as a secure data object.

The term “hierarchical components” refers to a security structure having a linear order such as TOP SECRET, SECRET, classified and unclassified classifications. The term “non-hierarchical components” refers to, for example, classifications such as, “noforn” (non-releasable to foreigners), “nuclear” (related to nuclear weapons), “intel” (related to intelligence activities) which are not put in any linear order.

The term “caveats,” as used herein, refers to additional rules and restrictions placed on how data objects may be used, by the “owner” or provider of the object. The restrictions can include a list of users to whom the object can be released. These additional rules and restrictions are placed in the security label.

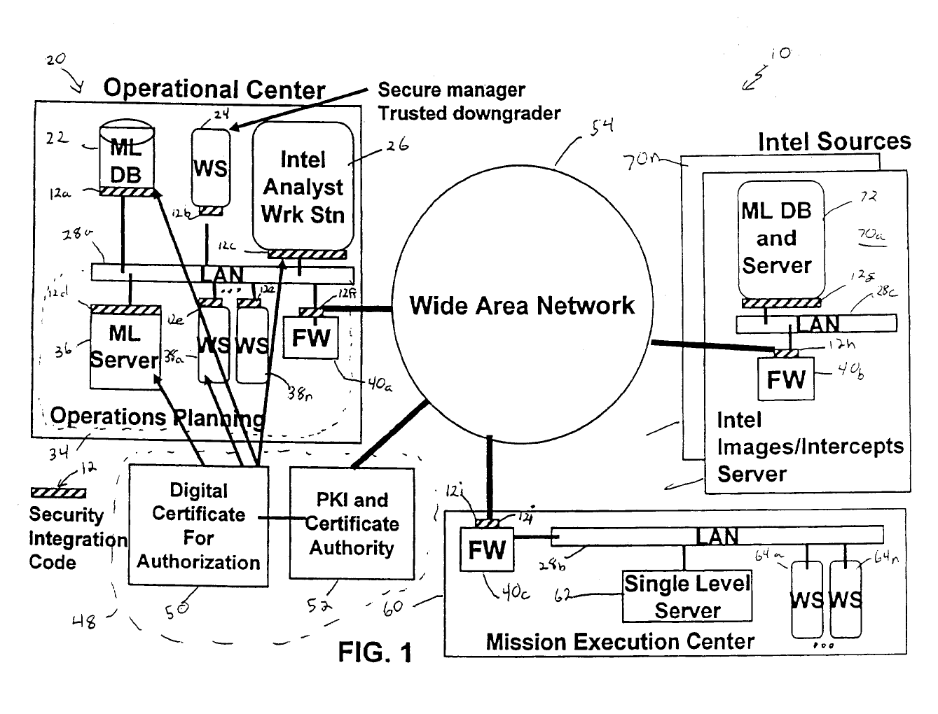

Referring now to FIG. 1, an exemplary multilevel security, multilevel protection system 10 includes an operational center 20 having at least one intelligence (Intel) analyst workstation 26 (also referred to as a user workstation, an Intel workstation or an application workstation) coupled to a local area network (LAN) 28a and running a portion 12c of a distributed application referred to as security integration code 12. The operational center 20 further includes a multilevel protection database (ML DB) 22 (also referred to as a multilevel security database MLS DB), and a secure manager trusted downgrader work station 24, each of which is coupled to LAN 28 and running portions of the security integration code 12a and 12b respectively. The operational center 20 further includes an operations planning component 34 having a multilevel protection sever (MLServer) 36, a plurality of workstations (WS) 38a-38n and a firewall 40a, each of which is coupled to LAN 28 and running further portions of the security integration code 12d, 12e and 12f respectively. The firewall 40a is further coupled to a wide area network (WAN) 54 via the portion of the security integration code 12f.

The operational center 20 is coupled to a PKI infrastructure 48 comprising a certificate authority 52 which provides a plurality of digital certificates 50 to the workstations and servers of the operational center 20. A plurality of intelligence (Intel) sources 70a-70n (generally referred to as Intel source 70) are coupled to the operational center 20 and to a mission execution center 60 through the WAN 54. Each Intel source 70 includes a multilevel protection database (ML DB) 72 coupled to a LAN 28c which is coupled to a firewall 40b. Each Intel source 70 collects information from related sources and files the information in the local database. Secure access to the Intel sources 70 provides aggregation of the data from various agencies. The firewall 40b is further coupled to a wide area network (WAN) 54. Both the (ML DB) 72 and the firewall 40b include portions of the security integration code 12g, and 12h respectively.

The mission execution center 60 includes a single level server 62 coupled to a LAN 28b which is coupled to a firewall 40c. The single level server 62 classifies information at one security level, regardless of the true classification of data due to the underlying system inability to protect data at multiple security levels. The firewall 40b is further coupled to a wide area network (WAN) 54. The firewall 40c includes security integration code 12i

The LANs 28a-28c can be hardwired or secure wireless LANS using 802.x protocols. The WAN 54 interconnects the mission execution center 60, the operational center 20 and one or more Intel source 70 by one or more logical links typically implemented using secure Internet protocols, for example IPSEC. Data leaving the operational center 20 can be encrypted and can be encrypted again when entering the WAN 54. The servers 36, 62, and 72 include portions of the security integration code 12 to control the distribution of data objects having security labels before processing of the data objects by services and resources on the servers 36, 62, and 72. Each portion of the security integration code 12a-12i can be viewed as a security integration code processor securely networked together to control the distribution of data objects.

It will be appreciated by those of ordinary skill in the art that the exemplary multilevel security, multilevel protection system 10 includes can include personal computers and other hardware devices, which can operate workstations, databases and servers providing resources. It will be appreciated by those of ordinary skill in the art that the connections among the various components in the operations center 20 can include but is not limited to routers, bridges and other networking components resulting in alternative network topologies. The operating system and firewalls 40 are augumented with the security integration code 12 to protect data from unauthorized intrusion.

The security integration code 12a-12i (collectively referred to as the security integration code 12) is implemented on various computing platforms and network components of the multilevel security, multilevel protection system 10 as a distributed application. The security integration code 12 has a component which runs on at least one intel analyst work station 26 and the secure manager trusted downgrader workstation 24. Portions of the security integration code also run on the firewalls 40, the ML DB 22, the ML server 36, and operations planning workstations 38.

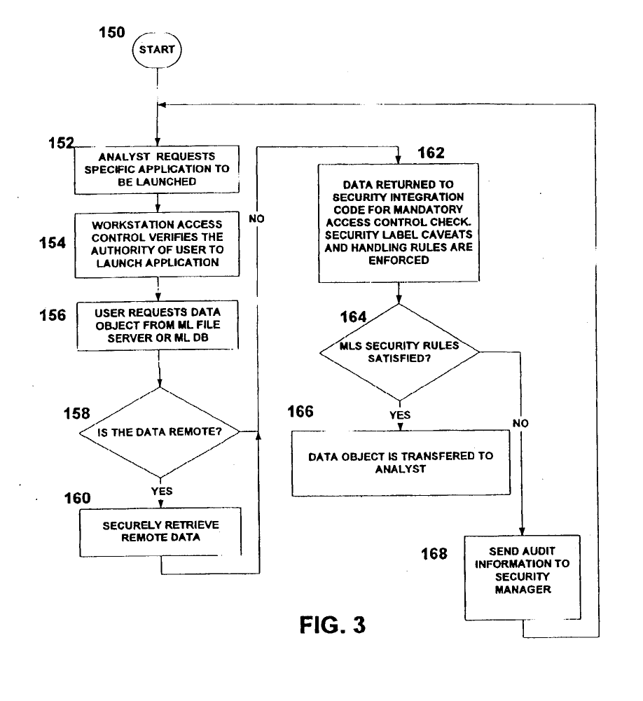

The security integration code 12 provides the protection processing of the secure data objects. The security integration code 12 can be implemented at several levels in the host processors, workstations, file servers, or any computer that processes secure data objects. The security integration code 12 can be located for example in the network protocol stack or at the interface between the operating system and the network interface. In operation, the security integration code 12 detects data objects having security labels leaving or entering the workstation, server, network devices, etc. The security integration code 12 guarantees that no unauthorized information can bypass the security integration check provided by the security integration code 12 (described in further detail in conjunction with FIGS. 3,and 7-9).

In a first embodiment, the security integration code 12 is inserted in the network protocol stack. As the secure data objects enter a computer system through the network connection, the secure data objects pass through the network protocol stack. Before information is passed from the protocol layer through the security integration code 12 to a higher layer protocol, the security integration code 12 checks the access rights of a user requesting the data object from the Intel workstation 26 and with security rules included in an extensible Markup Language (XML) security label carried within the information content. If the user is not allowed to view the information represented by the security label, the content of that information is not passed to the user. In the network layer, checking is performed to assure that the XML security label is included in each network packet including secure data objects to allow validation and security rule enforcement. In particular, if the security integration code 12 checking is implemented in the transport layer (e.g., TCP or UDP protocols), then the XML security label is included in each transport layer protocol data unit.

The security label is inserted into the appropriate protocol data unit (e.g., network packet or transport protocol data unit) for information leaving the workstation. The security clearance level in the security label is the security clearance level of the current user on the host machine. If the underlying workstation operating system supports the multilevel security mechanisms, then the security label is securely passed from the operating system to the security integration code 12. If the underlying operating system is trusted to pass the security label to the security integration code 12, then the appropriate security label will be provided by the security integration code 12. The operating system is multilevel secure (MLS) if it is trusted to associate security label to the data. Additional XML security labels could be embedded within the data (i.e., a security label is attached to data within a file). Additional security labels include information on how to handle the data, for example, an instruction providing that the data may be downgraded in 5 years from Jan. 3, 2003.

In a second embodiment, the security integration code 12is implemented within each underlying operating system interface to the network and the network communication protocol stack on the corresponding server, workstation or database. Secure data objects leaving the operating system and entering the network include security labels having the appropriate security clearance levels. If the underlying operating system is not multilevel secure, then the security clearance level of the data is the security clearance level of the user logon session. Alternatively, the highest clearance level of the user is used for the security label. If the underlying operating system is a multilevel secure system, then the security level of the process calling the network communication stack is used as its security label.

In a third embodiment specifically designed to operate with the Apple Computer OS, an approach similar to the Apple Computer File Management Tool Kit is used. In Apple Operating System, each time a user wishes to open, close, modify, create, or manipulate a file, the action must be passed to the file management tool kit. In this particular embodiment, the security integration code 12 is integrated with the file management tool kit to provide access to the secure data objects and associated security labels.

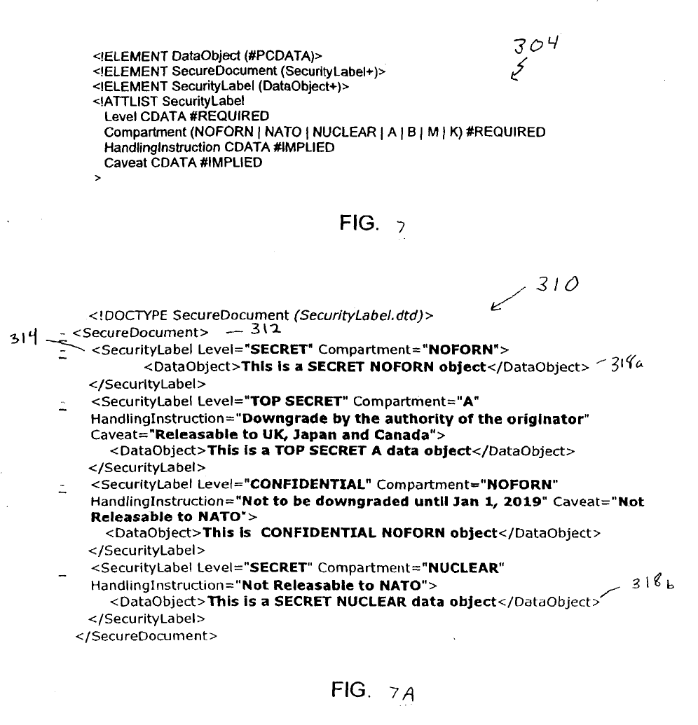

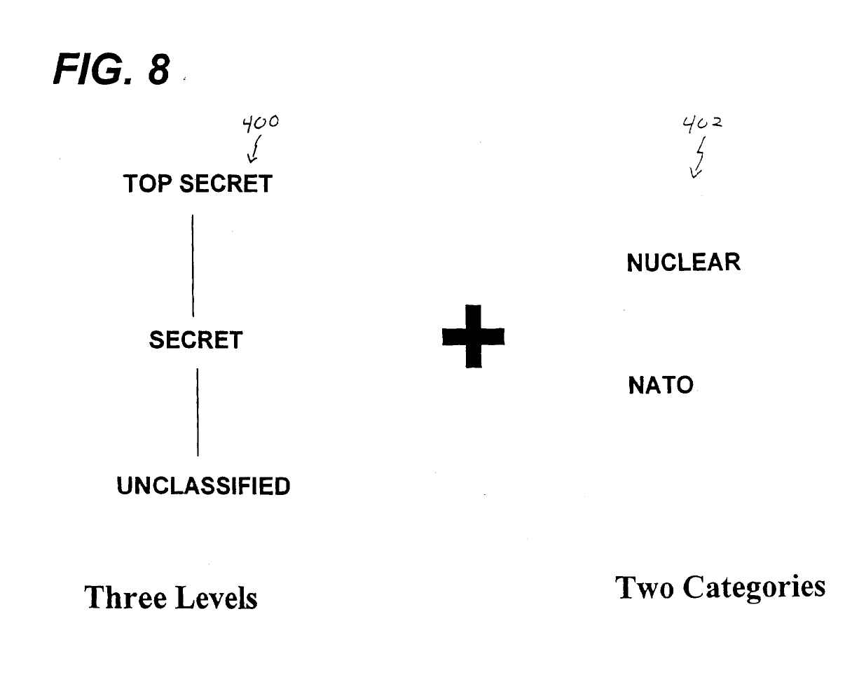

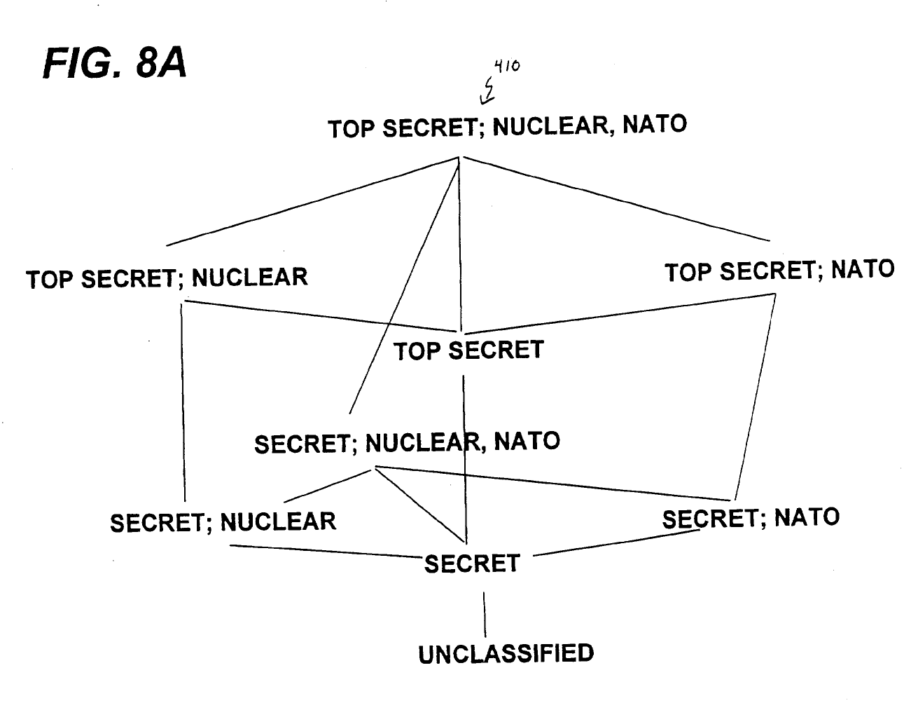

In processing the access control check, the security integration code 12 matches the user's session security level with the security level included in the security label, for example an XML security label (described in further detail in conjunction with FIGS. 7 and 7A). A dominance relationship (as described in further detail in conjunction with FIGS. 8 and 8A) is used in the processing of the security label. However, the processing for the caveat handling instruction within the security label is determined prior to generating the instructions. For example, the handling instructions could include the instruction that content is releasable to Canadian and UK, but not other foreigners. The security integration code 12 ascertains whether the user on the host machine is a US, Canadian, or UK citizen. To handle this type of caveat handling instructions, the security integration code 12 knows the meaning of the handling instruction when the security label is created. Logic is added to the security integration code to handle special handling instructions.

In operation, a mandatory access control mechanism implemented by the security integration code 12 determines the correct access control only if the security label of the data object is presented without any tampering, and can be trusted. Mandatory access control is a department of Defense (DoD) term that indicates the access control is required to meet the security policy, and is not at the discretion of the users. In one embodiment, an extensible markup language (XML), a secure hashing algorithm, and a digital signature are used to bind a data object to its security label. The data objects can be individual data (record) in a database, a view in a database, a specific word, a specific paragraph, a specific file, digital image; or any combination of electronic representation of digital information. The security label associated with each secure data object is used to enforce the mandatory access control rules stated by the security policy.

The secure manager trusted downgrader workstation 24 manages the security of the MLS/MLP system 10. The secure manager trusted downgrader work station 24 runs special code to change the embedded security level to a lower or another level, without violating the security policy. It is understood that the secure manager trusted downgrader workstation 24 can be implemented perform the trusted downgrade function on a separate workstation. The secure manager trusted downgrader workstation 24 collects the audit information from various platforms within the operational center 20, performs trusted downgrading and performs an intrusion detection function. The intrusion detection system detects malicious activities within the operation center 20. A new security label is generated by the secure manager trusted downgrader work station 24 for binding with data objects to provide secure data objects. The new security label is associated with the data object when the downgrade is approved.

By providing a mechanism for securely binding the security label to an object, the security policy is enforced in a distributed environment. The security label includes both the clearance level (hierarchical levels), and the compartments (non-hierarchical caveats). The mandatory access control mechanism operating on each workstation can validate the correctness of the security label for any data object arriving at the workstation and determine whether the user on that workstation has the proper clearance to receive the data object.

When the data object includes classified data, it is labeled with the highest classification included within that data object. The security label includes a hierarchical level plus a set of non-hierarchical handling instructions. The security label is then used by the mandatory access control code (enforced by security integration code 12) to determine whether the user on the workstation has the proper clearance to access the data object.

The security integration code 12 checks the mandatory access control, and the security integration code 12 must have the assurance that the security label has not been tampered either during transit or storage of the security label.

In one embodiment an extensible markup language (XML) is used to define the data object and its associated security label, and digitally sign the hash value that is derived from the data object and its security label. The digital signature prevents corruption or tampering of the data and the security label. It is signed and verified by the security integration code 12 at the sending node and receiving node, respectively. In one embodiment, the signing process includes the following four steps. First, XML elements are used to define the boundary of the data object for which the security label is assigned. Next, the security label includes the hierarchical and non-hierarchical components. The security label usually includes the security clearance level derived from the login session for the workstation originating the request for information. XML provides the processing instruction on how to interpret the security label. The processing instruction can be placed before the data object, within the data object or at the end of the data object. The XML notation attribute defines the application (i.e., Security Integration Code, the hashing algorithm, and digital signature mechanism) needed to do the processing. Next, a hashing algorithm is used to derive a digital digest from the security label and the data object. Finally, a digital signature is used to sign the digital digest.

An exemplary scenario for a multilevel security (MLS) application as implemented with the present invention includes one or more Intel operator in the operation center running applications on the Intel Analyst workstation 26. In conjunction with the application, the Intel operator accesses information from the MLS database 22 and MLS file server 36. The Intel operator can also use a collaboration tool, which interrogates remote centers, e.g. Intel sources 70, for additional information and retrieves the information, and transmits the information to local operational center 20. The Intel operator aggregates information from the above sources to determine the situation, before issuing a subsequent course of action. The course of action is subsequently transmitted to the mission execution center 60.

The information that the Intel Operator requests from the MLS DB 22 and ML File Server 36 is delivered in the form of secure data objects each having an associated security label. The security integration code 12 checks the security label after the data and security label are returned to the workstation. Mandatory access control check is performed to meet the MLS/MLP (multilevel protection) rules. Security label caveats and handling rules are enforced. After these checks explicitly grant access, the information is passed to the application program that made the original request on the user's behalf. The Intel operator uses the information to do the analysis. Intel operator writes data out to the database, file server, or sends message via the network. Data leaving the workstation is associated with a security label equal to the security level of the log in session of the user. If data leaving is taken from the database and file server, the corresponding security label that come with the data is also attached. The generation and attachment of security labels are performed by the security integration code 12. Collaboration and data mining tools determine whether additional information should be retrieved from remote locations (e.g., Intel sources 70).

In one embodiment, the system 10 the workstations, servers and databases operate on trusted operating systems, (for example, Trusted Solaris, Secure Linux, etc.). In this embodiment, trusted handshaking is used between security integration code 12 and the underlying operating system. A secure protocol, for example, IPSEC (Internet standard) is used to protect transmission among workstations having security integration code 12. Firewalls 40 are also IPSEC enabled. These measures protect all communication paths. The security integration code 12 is non-bypassable as is required in the MLS/MLP system 10. The security integration code 12 intercepts any data requests from the user workstation to the database or data files. The security integration code 12 can be hosted onto trusted UNIX platforms, and the trusted code is tied to the underlying trusted operating system.

It will be appreciated by those of ordinary skill in the art that the data objects can be encrypted or alternatively encrypted in transit to provide a higher level of security, but the system does not require any use of encryption to provide multilevel security. Transmission among workstations, databases, and file servers that are local or remote can be encrypted. Collaboration and data mining tools make initial requests to remote sites. When the data object is returned, the now secure data object includes the security label. When information is returned to the Intel Operator on the workstation, the security integration code performs the mandatory access control, caveats, and handling instruction checks.

Information transmitted among the MLS components is protected with IPSEC protocol. Traffic leaving or entering the Operation Center must be protected with IPSEC at the firewall (FW). IPSEC protects the confidentiality of information, and integrity of the security label. It will be appreciated by those of ordinary skill in the art that other secure protocol in addition to IPSEC may be used to provide security for the transmitted information.

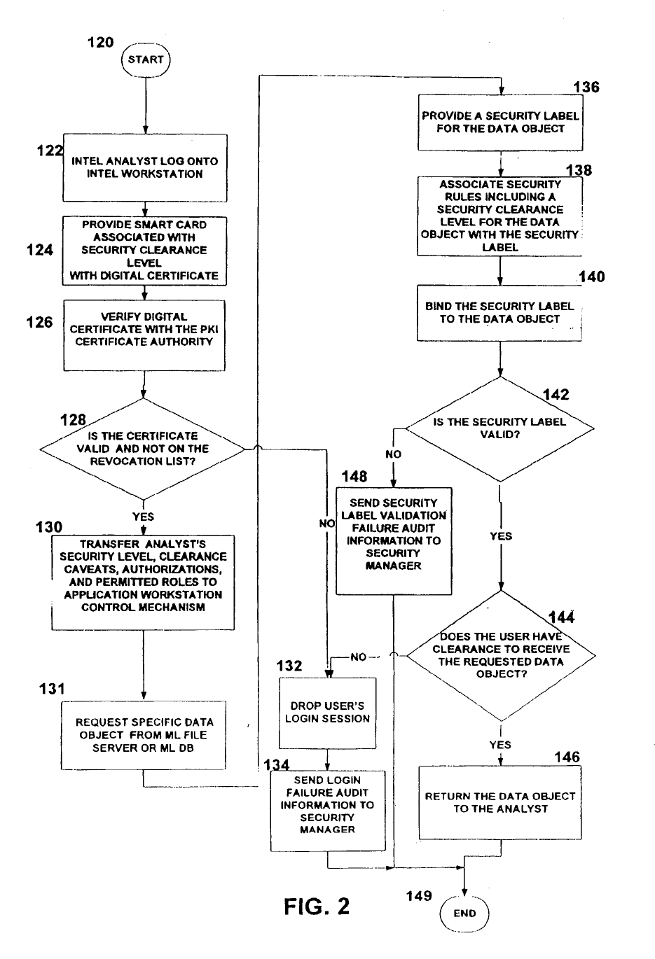

Referring now to FIG. 2, a flow diagram illustrates a process for user login to the MLS/MLP system 10 of FIG. 1 and to launch a requested application. The process begins at step 120, after which at step 122 the user, here an Intel analyst, logs onto the workstation, by specifying a login ID, password, security level for the session, and role for the session in conjunction a request for access to a data object. The login procedure can also include biometric information provided by the analyst. At step 124, as part of the log in process, the Intel analyst inserts an identification document, for example a government issued smart card. The smart card includes a set of digital certificates. A certificate authority service or software component issues the digital certificate adapted to be stored on a smart card. The digital certificate includes the user's security clearance level, for example, TOP SECRET, Secret, Confidential, Unclassified; clearance caveats, for example, COMSEC, Nuclear, U.S. Citizen; authorizations, for example, work on project XY123; and permitted roles, for example, system admin, security officer, air traffic control, tomahawk missile operator. The digital certificate can also include information related to the user's identity.

At step 126, the public key infrastructure (PKI) and one or more certificate authorities are accessed to authenticate the user's certificate. At step 128 it is determined whether the digital certificate is valid and that the digital certificate is not on the certificate revocation list. If the digital certificate is valid and not on the certificate revocation list processing continues at step 130, otherwise processing continues at step 132.

At step 130, the analyst's login and role are transferred to the portion of the security integration code 12 on the Intel workstation 26 to be used at step 144 to enforce security rules. Processing continues at step 136. At step 131, the analyst requests a specific data object from ML File Server 36 or ML DB 22. It will be appreciated by those of ordinary skill in the art that the request may be an explicit request for the specific data object or the request can result for the action of an application program execution on the Intel workstation 26.

At step 132, the user's login session is dropped because the digital certificate has been revoked or the user's login request is not within predetermined security parameters. Processing terminates at step 134, after the login failure audit information is sent to the security manager application on the secure manager trusted downgrader work station 24, and processing terminates at step 149.

At step 136, the secure manager trusted downgrader workstation 24 (FIG. 1) provides a security label for the data. A user with the appropriate role authorizes the downgrading action. At step 138, the secure manager trusted downgrader workstation 24 associates security rules including a security clearance level for the data object with the security label. At step 140, the secure manager trusted downgrader workstation 24 binds the security label to the data object forming the secure data object. At step 142, it is determined, after the secure data object reaches the analyst's workstation 26, by the portion of the security integration code 12c on the workstation 26 whether the security label is valid. If the security label is valid processing continues at step 144. Otherwise processing continues at step 148.

At step 144, it is determined whether the user has clearance to receive the requested data object. The determination involves, for example, comparing the user's security clearance level to the security clearance level required to access the data object. If provided in the security rules included in security label, the security integration code 12 performs other checks such as security category, clearance caveats and permitted roles. Other authorizations and handling instructions can also be provided and processed by the security integration code 12. If the analyst has clearance to receive the requested data object, processing continues at step 138 otherwise processing continues at step 132.

At step 146, the Intel workstation's access control mechanism in conjunction with the security integration code 12 allows the user to access the requested data object, and processing terminates at step 149. At step 148, the security label has been determined to be invalid and security label validation failure audit information is sent to the security manager on the secure manager trusted downgrader work station 24, and processing terminates at step 149.

Referring now to FIG. 3, a flow diagram illustrates an exemplary process to launch an application and request a remote data object from the MLS/MLP system 10. The process begins at step 150, after which at step 152 the user, here an Intel analyst, requests that a specific application be launched. It will be appreciated by those of ordinary skill in the art that in addition to allowing access to secure data objects, the security integration code 12 can allow the user to launch and run a secure application. As allowed by the assigned roles, the user can select approved application programs to execute. For example, an air defense operator can launch an application to check on the weapon status for air defense guns and missles. At step 154, the workstation 26 (FIG. 1) access control mechanism verifies the authority of the analyst to launch application. At step 156, the user requests specific information be retrieved from ML File Server 36, ML DB 22, or explicitly from a remote source (e.g., Intel source 70).

At step 158, it is determined whether the requested data is local to the ML File Server 36 or ML DB 22. If the data is local processing continues at step 162. Otherwise, processing continue at step 160. At step 160, the data is securely requested and retrieved including the security label and handling instructions from a remote source, for example the Intel source 70a (FIG. 1).

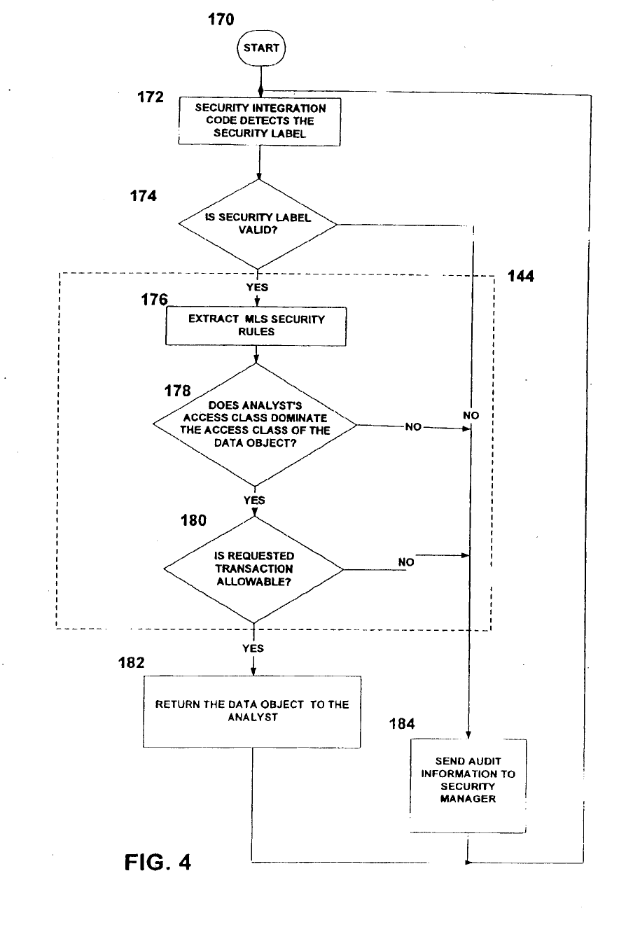

At step 162, the request data is returned to security integration code for a mandatory access control check. The security label caveats and handling rules are enforced at this time (as described in more detail in conjunction with FIG. 4).

At step 164 if is determined whether the MLS rules are satisfied. If the MLS rules are satisfied, data is returned to the user at step 162. Otherwise, the MLS security rule checks have failed and audit information is sent to the secure manager trusted downgrader work station 24 at step 168 and processing resumes at step 152 where additional requests to launch applications are initiated. Only after these checks explicitly grant access, is the data object passed to the application program that made the original request on the analyst's behalf. The Intel operator uses the information to do the analysis and writes the resulting analysis data back out to the database, file server, or sends messages via the network using security labels and the security integration code 12.

The security integration code 12 is non-bypassable (i.e., the security integration code 12 is trusted). This is a MLS/MLP requirement. The security integration code 12 is able to intercept any data requests from the user workstation to the database or data files. The security integration code 12 can be hosted, for example, onto any UNIX platform. The trusted security integration code 12 is interfaced to the underlying trusted operating system.

Referring now to FIG. 4, a flow diagram illustrates an exemplary process for enforcing the security rules in a security label. The process begins at step 170, after which at step 172 the security integration code 12 detects a secure data object and the security label associated with the secure data object in a network transmission. The checks in step 178 and 180 ensure that the requester (e.g., the analyst) is allowed to receive the information.

At step 174 the security integration code 12 verifies whether the security label is valid. The XML specifications (as described in more detail in conjunction with FIGS. 7 and 7A) are used to find out the boundary of the data object and a digital signature. The digital signature is checked to make sure the data object and the security label have not been modified during transmission. A hashing algorithm and the digital signature algorithm are used as defined in the XML specifications. After verifying the digital signature, the security integration code 12 has the assurance that the security label has not been tampered either during the transit or in storage.

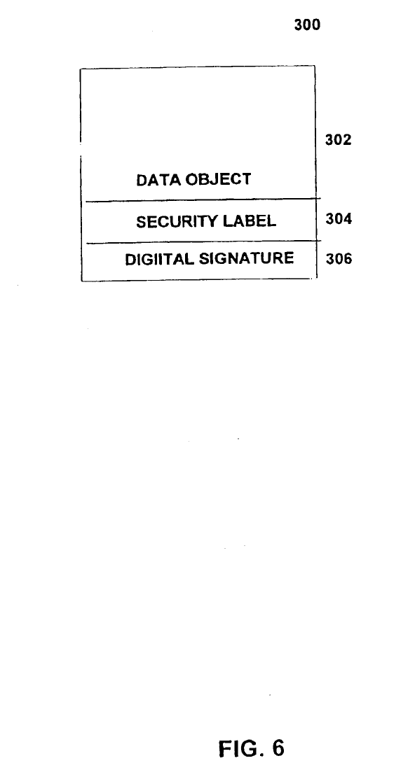

At step 176 the security integration code 12 extracts the MLS security rules (also referred to as security rules). It is understood, that the security integration code 12 may not be bypassed by the user to access information from ML DB 22 and ML Server 36. The binding of the security label to the information is described in conjunction with FIG. 6.

At step 178, the security integration code 12 applies the security rules to enforce the MLS mandatory access control by determining whether the analyst's access class dominates the access class of the data object. It is determined whether the analyst's security clearance as validated in conjunction with the digital certificate, allows access to the secure data object. In one embodiment, the security label is implemented in XML and is associated with specific data objects including files, portions of files and database objects, and is digitally signed to prevent tampering. When the data object includes classified data, it must be labeled with the highest classification included within that data object. This security label includes a hierarchical level plus a set of non-hierarchical handling instructions (described in conjunction with FIGS. 8 and 8A). This security label is then used by the mandatory access control code (enforced by security integration code 12 to determine whether the analyst on the Intel workstation has the proper clearance to access this data. If it is determined that the analyst's access class dominates the access class of the data object processing continues at step 180. Otherwise processing continues at step 184.

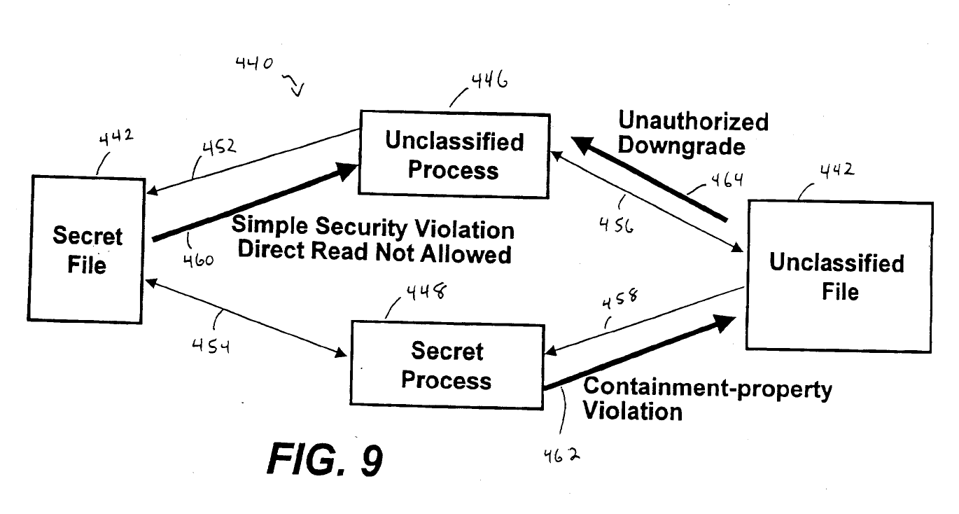

At step 180, it is determined whether the requested transaction is allowable. A transaction includes reading and writing data objects having different security levels from the application process (as determined from the analyst's logon security level). Downgrading the security level of a data object generally involves multilevel transactions (described in conjunction with FIG. 9). Transactions can also be prohibited by specific handling instructions as provided by caveats in the security label. For some situations, the user of the system is permitted to perform only a certain set of actions. If that is the case, step 180 can enforce this restriction. If the requested transaction is allowable processing continues at step 182. Otherwise processing continues at step 184.

At step 182, the data object is returned to the analyst, and processing resumes at step 172 to detect additional security labels. At step 184, the request for the data object is denied and audit information is sent to the secure manager trusted downgrader workstation 24.

Data objects that have been classified in error can be detected by looking through the entire data object for XML security labels. The data object should carry the highest classification security label as aggregated from all the security labels within it. The downgrader workstation can regradethe security label of the data object to the proper aggregation of the security labels contained within it. The security analyst discussed below verifies the new security label to ensure that the correctness. The security analyst also verifies that the higher security level is due to the aggregation of information. If the aggregation causes the total data object at a higher classification, then the proper security level is assigned to the data object.

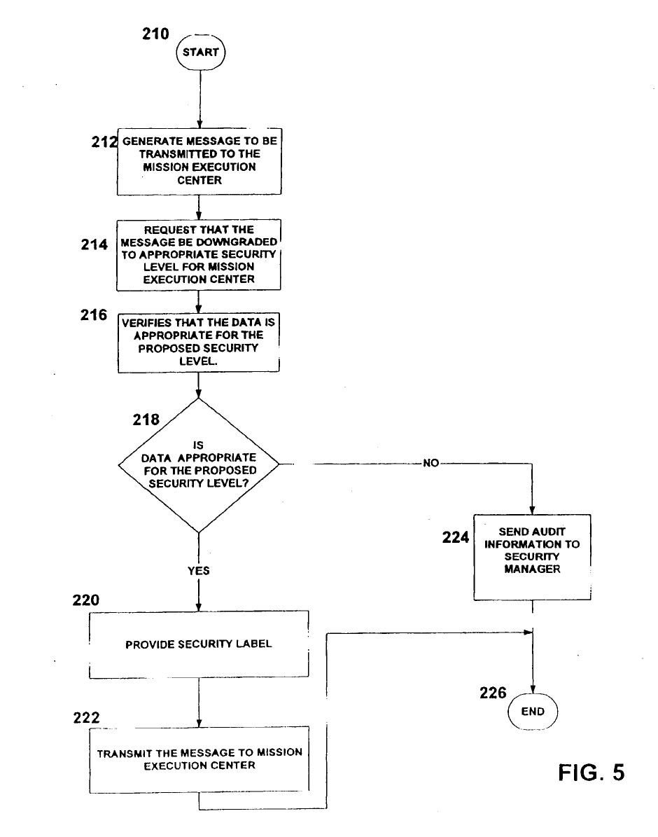

Now referring to FIG. 5, a flow diagram illustrates an exemplary process to issue a mission execution order (e.g., an order from an air base to an F16 fighter crew) using the MLS/MLP system of FIG. 1. The process begins at step 210, after which at step 212 a message is generated to be transmitted to the mission execution center. At step 214 the analyst requests that the message be downgraded to appropriate security level for Mission Execution Center.

Analysts may propose to downgrade a specific security label associated with a specific data object. The data object generated by the analyst is classified at the level that the analyst login session defines. This level may be at a higher level than the mission execution center can receive. The analyst must make sure the content of the data object contains no information higher than the proposed new security label, as the analyst should be in the best position to know this.

In one embodiment, the system requires that a second analyst, with access to a data object, “cosign” the request to downgrade the specific security label. Alternatively, the owner of the data object can downgrade the specific security label of the secure data object (described in conjunction with FIGS. 9 and 9A).

At step 216, the secure manager trusted downgrader workstation 24 verifies that the data is appropriate for the proposed security level (according to the criteria described in conjunction with FIG. 9). At step 218, it is determined whether the data is appropriate for the proposed security level. If the data is appropriate for the proposed security level, the secure manager trusted downgrader workstation 24 provides a security label at step 220. Otherwise, downgrading is not possible and audit information is sent to the secure manager trusted downgrader workstation 24 in step 224, and processing terminates at step 226.

At step 220, the data object with the associated security label (i.e., the secure data object) is returned to the Intel workstation 26. At step 222, the Intel workstation 26 transmits the message including the tasking order to mission execution center 60, and processing terminates at step 226.

In an alternative embodiment, the system 10 optionally includes a “sniffer” (network protocol monitor, for example Raytheon Company's Silent Runner), operating on the secure manager trusted downgrader workstation 24 for providing additional security management tools for managing the system 10. In a further alternate embodiment, the system 10 includes an automatic communications filter operating on the secure manager trusted downgrader work station 24 (e.g. Lockheed Martin Corporation's Radiant Mercury system) for automatically sanitizing information transmitted between secured gateways in the network searching for keywords which should not be passed through the gateway.

Now referring to FIG. 6, an exemplary multilevel secured data object 300 includes a data object 302 (also referred to as an information object 302), a security label 304 and a digital signature 306. The security label is bound to any form of data objects. The security label 304 is embedded with the data object 302. The security label 304 is transported via the secure communications network (local 28 or wide area network 54) to maintain the integrity and trustworthiness of the security label 304.

The security label 304 can be processed by different operating systems to facilitate interoperability. In one embodiment, XML is used to represent the security label, the intent of the information owner on how to protect the data object, is transmitted within the security label 304 as a set of security rules to the receiving workstation. The security rules included in the security label 304 direct the receiving workstation to perform the clearance checks for access to the data objects and possible modification of the security clearance level of the data objects.

In processing the security rules, the security integration code 12 compares the user's session security level with the security level included in the XML security label. For example, the analyst's session security level as provided in the analyst's digital certificate and the security level included in the XML security label 304 are compared with respect to a security dominance relationship. The dominance relationship is described in conjunction with FIGS. 8 and 8A. The security rules can also provide additional handling instructions referred to as caveats. The rules for processing for the caveat handling instructions within the security label are determined prior to use.

For example, the handling instruction can include a rule that content is releasable to Canadian and UK citizens, but not other foreigners. The security integration code ascertains whether the analyst on the Intel workstation is a US, Canadian, or UK citizen. The analyst's citizenship is verified at login time by means of the analyst's digital signature. To handle this type of caveat handling instructions, the security integration code 12 knows the meaning of the handling instruction when the security label is created.

Now referring to FIGS. 7 and 7A, an exemplary representation of multiple levels of security in an electronic document includes a plurality of eXtensible Markup Language (XML) tags. The XML model includes a hierarchical document format beginning with the <SecureDocument> container tag 312. The SecureDocument includes multiple labeled elements of the secure document encapsulated within the <SecurityLabel> container. The actual document content is included within the <DataObject> container 318 and may include encrypted text, graphics or a link to an external document. The <DataObject> container 318 may specify encryption characteristics of the secured data. Additional details of the encryption model and the specification of encryption parameters are optionally provided.

Now referring to FIG. 7A, an exemplary XML Security Label data type definition for the Security Labels includes the DataObject 318, SecureDocument 312 and SecurityLabel 314 elements. The DataObject element 318 may include arbitrary data. The SecureDocument element 312 includes one or more SecurityLabels 314. The SecurityLabel includes one or more DataObjects 318. Each SecurityLabel element 314 includes several attributes, here for example, Level, Compartment, HandlingInstruction and Caveat. The Level and Compartment attributes are required and the HandlingInstruction and Caveat attributes are optional.

In the XML example of FIG. 7A, the secure document specification includes one <SecureDocument> container 314 with four secure parts included in a <SecurityLabel>. The secure parts are included in a <DataObject> container. In this example the data parts are not encrypted. It is noted that the document has data objects with multiple levels of security including hierarchical and non-hierarchical components, for example:

1. Security Level: SECRET, Compartment: NOFORN;

2. Security Level: TOP SECRET, Compartments: A, Handling Instruction: Downgrade by the authority of the originator Caveat: Releasable to UK, Japan, and Canada

3. Security Level: Confidential, Compartment: NOFORN; Handling Instruction: Not to be downgraded until Jan. 1, 2019; Caveat: Not Releasable to NATO

Specific process instructions included in the XML specifications are performed. For example, “Not to be downgraded until Jan. 1, 2019” means the downgrader may not downgrade the data object. “Not releasable to NATO” means the analyst should know that the data object may not be delivered to a network address in Europe (i.e., IPv6 addresses have been divided out by continents. So this check can be processed automatically.)

Now referring to FIGS. 8 and 8A a set of security levels 400 and a set of categories 402 are combined to form a partial ordering 410. The security levels 400 are generally linearly ordered hierarchical components, for example:

Unclassified <CONFIDENTIAL<SECRET <TOP SECRET.

In order to obtain information within the MLS/MLP rules, an analyst must possess an access class whose level is greater than or equal to the level of the access class of the secure data object. Categories 402, for example Nuclear andNATO, are generally non-hierarchical components independent of each other and not ordered. To obtain access to secure data objects, a user must possess an access class whose category set includes all the categories of the access class of the secure data object to be accessed. Combining the security levels, which form a lattice, and categories forms the partial ordering 410.

Now referring to FIG. 9, a set of authorized transactions 452-458 and a set of unauthorized transactions 460-464 accessing secure data objects in a secret file 442 and an unclassified file 444 are shown. In one embodiment, an analyst executing a pair of applications on a workstation (represented here by an unclassified process 446 and a secret process 448) can only read an object if the access class of the user dominates the access class of the object. A user can read down the hierarchy as indicated by transactions 454, 456 and 458 but cannot read up the hierarchy as indicated by unauthorized transaction 460.

The user can write up and on the same level as indicated by transaction 452 and 454 but cannot write down as indicated by transaction 462. Because simple security cannot prevent write-down, the process 448 can write data objects into a file whose access class is less than its own for example transaction 462. In the absence of the present invention, it might be possible for the unclassified process 446, to read secret information written in transaction 462. However, the present invention prevents transactions 462 followed by transaction 464 which results in an unauthorized downgrade. An unauthorized downgrade can be prevented, as in step 178 of FIG. 4. An analyst can only write an object if the access class of the analyst is dominated by the access class of the object. The security classification of the data object is higher than the analyst. Hence, whatever the analyst writes, the classification cannot be higher than the security classification of the data object.

Having described the preferred embodiments of the invention, it will now become apparent to one of ordinary skill in the art that other embodiments incorporating their concepts may be used. It is felt therefore that these embodiments should not be limited to disclosed embodiments but rather should be limited only by the spirit and scope of the appended claims. All publications and references cited herein are expressly incorporated herein by reference in their entirety.

What is claimed is:

1. A method for providing multilevel security for a data object requested by a workstation user, the method comprising:
providing a security label for the data object;
associating security rules including a security clearance level for the data object with the security label;
binding the security label to the data object;
validating the correctness of the security label;
associating the user's security clearance level with at least one user certificate;
verifying the at least one user certificate; and
determining whether the user has clearance to receive the requested data object.

2. The method of claim 1 further comprising providing the at least one user certificate on an identification document adapted for securely storing the at least one user certificate.

3. The method of claim 2 wherein the identification document is a smart card.

4. The method of claim 1 further comprising:
detecting the security label in a network packet;
extracting the security rules from the security label; and
applying the security rules.

5. The method of claim 4 wherein applying the rules associated with the security label comprises determining whether the user clearance dominates the data object clearance using the security rules.

6. The method of claim 5 wherein detecting the security label comprises:
detecting an XML security label data type definition.

7. The method of claim 6 wherein the XML security label data type definition comprises:
a level attribute; and
a compartment attribute.

8. The method of claim 7 wherein the XML security label data type definition comprises at least one of:
a handling instruction attribute; and
a caveat attribute.

9. The method of claim 1 wherein the data object comprises at least one of: a record in a database;
a view in a database;
a specific word;
a specific paragraph;
a digital image;
a specific file; and
an electronic representation of digital information.

10. The method of claim 1 wherein binding the security label to the data object comprises:
deriving a hash digest from the security label and the data object; and
digitally signing the hash digest.

11. The method of claim 10 wherein validating the correctness of the security label for the data object comprises verifying the digital signature.

12. The method of claim 1 further comprising associating the user certificate with at least one of:
a security category;
a clearance caveat;
an authorization; and
a permitted role.

13. The method of claim 1 wherein the security label includes at least one of:
a security clearance level;
a security category;
a clearance caveat; and
a handling instruction.

14. The method of claim 1 wherein the security label comprises at least one statement in an extensible markup language.

15. The method of claim 14 wherein the extensible markup language is XML.

16. The method of claim 1 wherein the security label comprises a security clearance level.

17. The method of claim 16 further comprising downgrading the security label security clearance level.

18. The method of claim 17 wherein the data object is transmitted to a mission execution center.

19. The method of claim 1 wherein the data object is located on a remote intelligence source workstation.

20. A multilevel security system for controlling access to data objects in a secure network comprising:
a plurality of security integration code processors coupled to the secure network;
a secure manager workstation coupled to one of the plurality of security integration code processors;
at least one application workstation coupled to a corresponding one the of the plurality of security integration code processors; and
at least one of a multi-level protection database and a multi-level protection server coupled to a corresponding one of the plurality of security integration code processors.

21. The system of claim 20 wherein the application workstation is adapted to receive an identification document.

22. The system of claim 21 wherein the identification document comprises a smart card associated with at least one user certificate.

23. The system of claim 22 further comprising an interface to a public key infrastructure (PKI) to verify the at least one user certificate.

24. The system of claim 20 further comprising:
a first firewall coupled to a corresponding one of the plurality of security integration code processors;
a secure wide area network coupled to the first firewall;
an Intel source workstation coupled to the secure wide area network.

25. The system of claim 20 further comprising:
a first firewall coupled to a corresponding one of the plurality of security integration code processors;
a secure wide area network coupled to the first firewall;
a mission execution center coupled to the secure wide area network.

26. The system of claim 20 wherein at least one of the plurality of security integration code processors is implemented in a protocol stack in at least one application workstation.

27. The system of claim 20 wherein at least one of the plurality of security integration code processors is implemented in an operating system interface to the network in at least one application workstation.

28. The system of claim 20 wherein the secure network includes an IPSEC protocol.

29. The method of claim 20 further comprising a trusted downgrader workstation coupled to one of the plurality of security integration code processors.
